(19) United States
(12) Patent Application Publication
(10) Pub. No.: US 2006/0226973 A1
(43) Pub. Date: Oct. 12, 2006

(54) Device, system, and method for providing hazard warnings

(75) Inventor: George N. Catlin, Grove City, OH (US)

Correspondence Address: REINHART BOERNER VAN DEUREN P.C., 483 NORTH MULFORD ROAD, SUITE 7, ROCKFORD, IL, 61107, US

(73) Assignee: Ranco Incorporated of Delaware, Wilmington, DE (US)

(21) Appl. No.: 11/093,957

(22) Filed: Mar. 30, 2005

(51) Int. Cl. G08B 1/08

(52) U.S. Cl. 340/539.11

(57) ABSTRACT

The present invention provides a wearable mobile device that receives hazardous condition threat messages from a hazardous condition detection system. The device includes a receiver that receives the warning transmissions generates a physical sensation to alert a user of the warning. The device further includes a display that can provide the user with helpful information relating to the warning. Priority logic prioritizes the received threat messages for display and notification based on their urgency. A user input is further included to enable the user to input control functions to the device. A transmitter allows the device to transmit signals to the hazardous condition detection system.

### FIELD OF THE INVENTION

The present invention relates generally to devices, systems, and methods for providing warnings of detected hazards, and, more particularly, to a wearable mobile device that alerts a user of the detected hazard.

### BACKGROUND OF THE INVENTION

Most home or commercial structures are commonly installed with an alarm system that is intended to protect occupants from harm. As is well known in the art, these conventional alarm systems are adapted to send audible warnings to alert the occupants of various local hazards detected within the environment. These local hazards may include harmful elements, such as intruders, smoke, fire, and/or carbon monoxide poisoning. Other alarm systems may provide alerts for more regional hazards, e.g. weather alerts for particular counties, etc. When the alarm system detects the hazard, it typically sounds an audible alarm that is meant to draw the occupants' attention to the existence of the hazard so that appropriate action may be taken by the occupants to avoid harm.

One problem with such conventional alarm systems is that some occupants may not hear the audible alarm because of a health condition, because they are sleeping, because they are located a distance from the detector that is sounding the alarm, etc. In fact, many people are injured in home fires, tornados, etc. because they slept through the standard alarm warnings. While various alerting devices are used to overcome these problems, each suffers from problems which limit their effectiveness. For example, some alerting devices directed to the hearing impaired uses bright flashing white xenon strobe lights in addition to an audible warning to alert people of the detected hazard. However, the flashing lights may not be seen or may not be enough of a distraction to wake a person from deep sleep. Another prior alerting system utilizes a vibrating pad that is placed under the pillow. However, this method is also inadequate because the occupant may not be sleeping on the pillow when the hazard is detected because the pillow or the pad may have moved or fallen on the floor, or because the occupant is simply not sleeping with his or her head on the pillow. Further, depending on the thickness and material of the pillow, the vibrations may be dampened sufficiently so that the occupant does not feel them.

Another problem with current hazard detecting and alerting systems is that the occupants do not have or may not have access to any information of the location or type of the detected local hazard. While centralized systems may include a central terminal on which such information may be displayed, this is little help for the occupant who is not in proximity to such central terminal. As a result, the occupant may actually move toward the direction of the local hazard instead of trying to get away from the hazard, or may take action that is inappropriate for one type of hazard because they mistake the alarm for another hazard.

There exists, therefore, a need in the art for a new and improved alarm system that can interface with hazard detecting and alarming systems, and that can alert an occupant of a detected hazardous condition despite the occupants' sleeping pattern and/or health conditions. Further, there exists a need for such an alarm system that may provide the occupants with helpful information during this critical situation.

### BRIEF SUMMARY OF THE INVENTION

In view of the above, it is an object of the present invention to provide a new and improved alarm system that can address these and other shortcomings of the prior systems and methods. More particularly, it is an object of the present invention to provide a new and improved mobile alerting device that may be worn by an individual. Still further, it is an object of the present invention to provide a new and improved mobile alerting device that is capable of receiving hazard warnings and alerting the wearer of the warning in such a manner so as to overcome the above described and/or other problems existing in the art.

In one embodiment of the present invention, a wearable mobile device includes a receiver that receives a warning transmission from a hazardous condition detection system. This transmission may take various forms, including radio frequency (RF), infrared (IR), auditory, etc., and may take the form of a proprietary protocol, e.g. a wireless smoke detector system, or public frequency, e.g. weather radio band. Information regarding the type of hazard warning and/or instructions for the wearer is displayed to the user using a display on the device. Preferably, responsive to the transmission a vibrator, electrical circuit, thermal circuit, etc. provides a physical sensation to the wearer, in addition to or as an alternative to an audible alarm. Such stimuli may be sequenced, repetitive, variable in intensity, etc. so as to maximize the probability of alerting the wearer. In this way, the wearer may be alerted of the received transmission and detected hazard, even if the wearer is asleep when the hazard is detected.

In a further embodiment of the present invention, the device includes a user interface that enables the user to set/access various control and alerting functions. In a preferred embodiment, these functions may include general pager functions, text messaging, silent ring alerts, security alerts, and all standard wrist watch functions. Through the inclusion of a wireless transmitter, the user may also send control signals to the hazard detection and alerting system to query for information, enable hush and locate control functions, etc.

In another embodiment of the invention, the wearable mobile device is integrated into an alarm system that includes a hazard detector to detect hazardous conditions within an environment. The hazardous condition detector sends a warning transmission responsive to the hazardous condition detected. A control panel receives the transmission and appropriately sends out instructions responsive to the transmission. In response to the instructions from the control panel, an alarm is sounded within the environment to alert occupants of the warning. Also in addition to the transmission from the control panel, the wearable mobile device sends a physical sensation to a user wearing the device.

In yet another embodiment of the present invention, a method for providing hazard warnings is provided that includes the steps of receiving a warning transmission, displaying a message related to the warning transmission to a user, and sending a physical sensation to alert the user of the received warning transmission, wherein the physical sensation is of a sufficient magnitude to wake the user from sleep.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a simplified illustration of a home environment containing a local hazard warning system in which the system of the instant invention is installed;

FIG. 2 is an illustration of the user wearing the wearable mobile device shown in FIG. 1 being awoken from sleep;

FIG. 3 is an illustration of one embodiment of the wearable mobile device used in the present invention;

FIG. 4 is an illustration of exemplary display screen of the wearable mobile device according to one embodiment of the present invention;

FIG. 5 is an illustration of an additional exemplary display screen of the wearable mobile device according to one embodiment of the present invention; and

FIG. 6 is a flow chart illustrating a method for alerting the user implemented in the wearable mobile device according to one embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

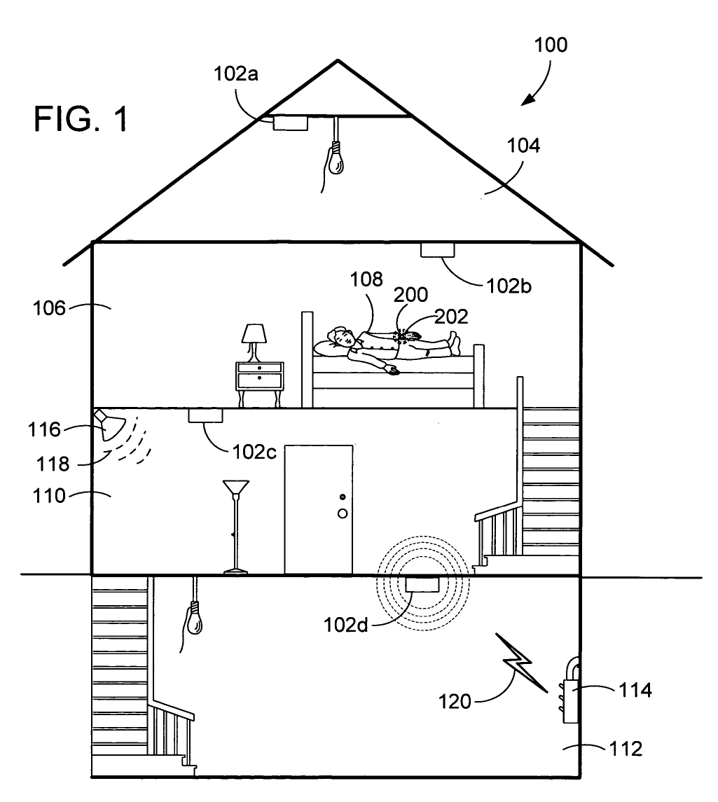

FIG. 1 illustrates a simplified home environment 100 into which the system of the present invention finds particular applicability. However, one skilled in the art will recognize that the system of the present invention is not limited to a home environment, but may also be installed in a commercial environment, etc. Further, while the environment illustrated in FIG. 1 utilizes a centralized detection and alerting system having separate detectors and alarm units, one skilled in the art will recognize from the following description that the present invention is applicable to other environments that include stand alone detector and alarming units, such as stand alone smoke detectors, etc. that can transmit a hazardous condition detected signal in addition to sounding an audible alarm.

The home environment 100 of FIG. 1 has installed therein a centralized alarm system that is intended to alert the occupants of a hazardous condition to protect the occupants from harm. The alarm system includes multiple local hazard detectors 102a, 102b, 102c, and 102d throughout the home environment 100 for detecting local hazardous conditions at different designated locations. Specifically, as shown, the detector 102a is found in an attic location 104, and detector 102b is placed on the second floor 106 where an occupant 108 is shown to be sleeping. The remaining detectors 102c and 102d are found respectively in a first floor 10 and a basement 112. This exemplary centralized system also includes at least one alarm unit 116 for alerting the occupants of the house of the detected hazardous condition. This operation is controlled from a central control unit 114. This central control unit 114 is preferably in wireless contact with the detectors and alarm units, although it may utilize wired connections. In either case, the central control unit 114 includes wireless transmission capability.

In the present invention, local hazards refer to any type of hazardous condition that may harm either the occupants or structure within the environment. In particular, local hazards may include a variety of harmful elements, such as intrusion, fire, smoke, carbon monoxide gas, gas poisoning, and flammable vapor, but these examples of local hazards are not exclusive. Other harmful elements are contemplated, and they are within the scope of the present invention. Moreover, the proximity of the local hazards can be customized according to the various environments and needs of the implementation. It can be as simple as the home environment 100 shown in FIG. 1, as widely dispersed as a county or region, or as complex as a campus having multiple structures. Again, these various alternative embodiments of different dwelling, commercial, and geographic areas are within the scope of the present invention.

To illustrate the functionality of the present invention, FIG. 1 shows detector 102d detecting a local hazard, such as carbon monoxide, in the basement location 112. In response to the local hazard detected, the detector 102d sends a warning message to the control panel 114. In turn, the control panel 114 directly or indirectly sends instructions to an alarm 116 that sounds an audible warning 118 within the home environment 100. The control panel 114 may also contact the proper authorities or a corporate based dispatch and monitoring center. However, the audible warning 118 from the first floor location 110 of the alarm unit 116 may not be effective in waking up the occupant 108 from sleep in time to take appropriate action for the detected hazard.

In accordance with an aspect of the present invention, the control panel 114 sends a transmission 120, preferably a wireless transmission, to a wearable mobile device 200. Alternatively, and to allow for greater applicability of the mobile device 200 of the present invention, this device 200 may simply receive a wireless signal transmission to the alarm 116 from the controller 114, without requiring a separate signal transmission. Control logic within the device 200 will decode the wireless transmission to determine the type of threat detected. Based on this information, the mobile device 200 of the present invention provides an appropriate or programmed alert, which may include a physical, audible, etc. alarm and information displayed on the device's screen as will be discussed more fully below.

As discussed above, the device 200 of the present invention may also receive transmissions from stand alone hazardous condition detectors that include wireless transmission capability. The control logic within the device 200 decodes the information in the transmission and provided the appropriate or programmed response. By appropriate response it is meant that the device 200 provides, e.g., a carbon monoxide warning when a carbon monoxide condition is sensed by a detector, a smoke warning when a smoke condition is detected by a detector, etc. By programmed response it is meant that the device 200 provides the ability for the user to select the type of alarm, e.g. audible, physical, etc., that will be provided when a detected hazard is signaled, as will be described more fully below.

Although FIG. 1 shows the local hazard detector 102b of the alarm system triggering the device 200, the present invention contemplates other transmissions that would also trigger the device. In one embodiment, the wearable mobile device 200 is adapted to receive open standard public hazard warnings broadcasts by The National Oceanic and Atmospheric Administration Weather Radio or the Emergency Alert System, including in one embodiment Amber Alerts. In another embodiment, the device 200 can be implemented on a radio frequency network that is local in coverage, and the device can passively or actively monitor the network for transmission. In a further embodiment, the device 200 is designed to receive information coded in infrared light waves. In a still further embodiment of the present invention, the mobile device 200 may also receive and decode sound waves. Such decoding relies on the reception of sound waves from smoke and/or carbon monoxide detectors, etc. that broadcast audible warnings in compliance with the tone patterns dictated by the applicable industry standard. Such an embodiment provides operability in environments that have detectors that do not provide any wireless transmissions, but that comply with the standard audio patterns of tone and silence defined for all current smoke or carbon monoxide detectors.

In response to the wireless transmission of the detected local hazard, depending on the source of the transmission, the wearable mobile device 200 worn by the occupant 108 sends a physical sensation 202 in order to wake up and alert the occupant 108 of the hazard warning. To distinguish different occupants in the home environment 100, for clarity, an occupant who is wearing the device 200 will herein be referred to as a user.

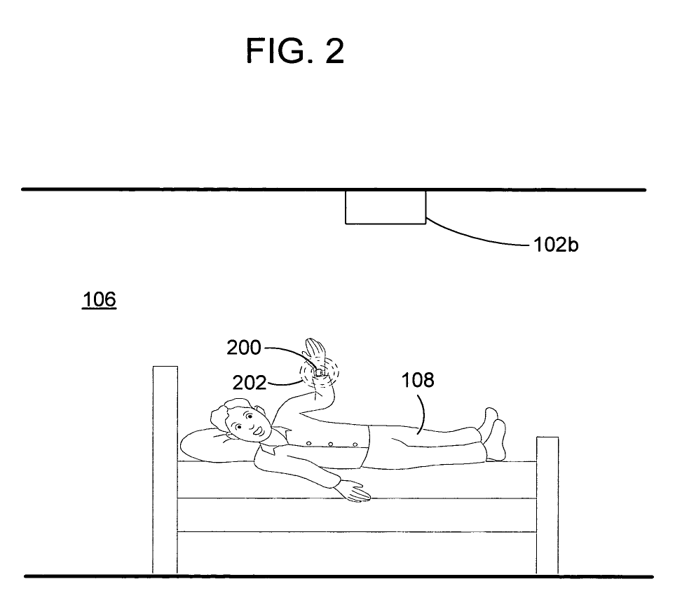

Turning next to FIG. 2, the user 108 is awoken by the physical sensation 202 from the wearable mobile device 200 at the second floor location 106 of the home environment 100. The wearable mobile device 200 can send the physical sensation 202 of various magnitudes or a fixed magnitude. Importantly, the strength of the physical sensation should be sufficient to wake the user from sleep. As a result of the physical sensation 202, the user 108 is awoken to the hazardous condition so that the user 108 may gather the family and escape the dangerous situation or take other appropriate action depending on the type of detected hazardous condition. Because the alarm system does not rely solely on an audible alarm, the wearable mobile device 200 is particularly useful for the handicapped. For example, the wearable mobile device 200 will be able to alert both deaf and blind people.

As indicated above, the device 200 can provide other alerts, such as audible alerts including tone patterns and synthesized or recorded voice messages, flashing lights, illumination of the display, etc. Further, the physical sensation provided in the preferred embodiment can be a vibration, shock, temperature, or combination of any of these physical alerts. In another embodiment of the present invention, the device 200 provides its alerting according to the importance of the transmitted data to the device 200. The varying levels of importance or priority can be retained in the device 200 as manufactured, or alternatively, the user can modify the priority or response to the transmission. In one example, a life threatening condition would activate the higher levels of alarm response, which may include loud sounds in appropriate frequency ranges, recorded voice messages, audible messages stating the nature of the hazard, and physical sensations emitted in multiple strengths, while a non-life threatening alert could be restricted to non-audible alarms or audible alarms that are only activated when the user is not asleep. Such determination may be made by the time of day, programmed by the user, or sensed by the device 200 based on user movement, etc.

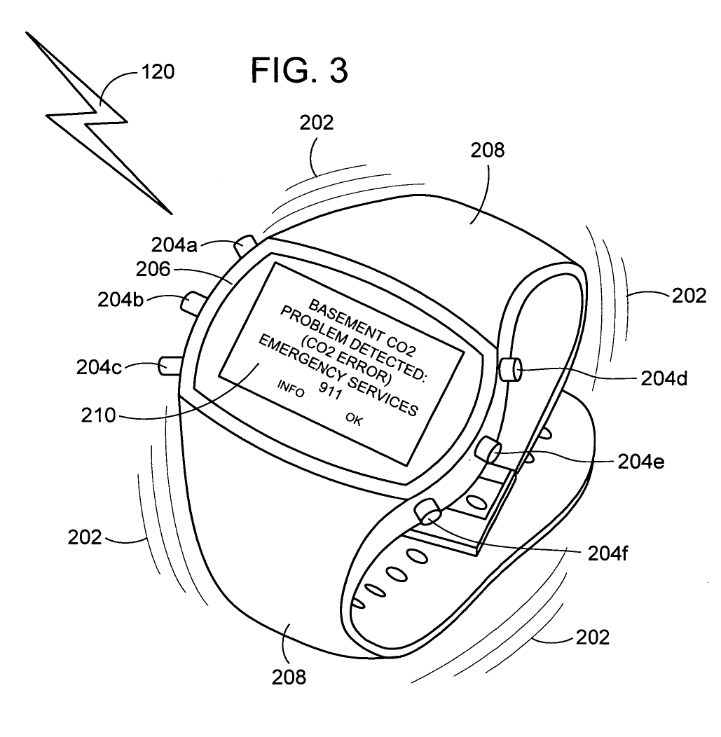

In one embodiment of the present invention, the wearable mobile device 200 is implemented as a wristwatch, such as illustrated in FIG. 3. It should be noted, however, that the device 200 can be implemented in numerous ways. The point is to provide a comfortable device that can be easily kept near or more preferably in contact with the body of the person wearing the device 200 to facilitate the alarm functions of the system. As a result, other embodiments, such as an armband or a clip, can also be used for the wearable mobile device 200. However, the advantage of using the wristwatch 200 is that it can easily include all the normal functions of a typical wristwatch. In fact, there are currently wristwatches that provide Personal Digital Assistant functions such as alarms, pages, messages, appointments, and, news. Unfortunately, such systems do not provide any interface to hazardous condition detectors or other local warning or alerting systems.

With the use of the device 200, all alerts could be scaled back for the initial warning, meaning the alert on the device can get stronger as the alert continues, which would allow the user to avoid an undesirable alert. To ensure that a user does not simply ignore the alert, e.g. if the user is sleeping, it is preferable that the alert be repeated until a conscious, intelligent response can be obtained. Such a response may utilize any one of the user input buttons 204a, 204b, 204c, 204d, 204e, and 204f, a touch screen 210, or soft keys on the device 200. In this embodiment the wristwatch 200 includes a main watch body portion 206 and a wristband portion 208. In this configuration the physical sensation 202 generated during an alert condition can be generated by the main watch body portion 206, the wristband 208, or both to ensure that the user feels the physical sensation. As described previously, the physical sensation 202 can include any contact that can alert the user of the hazard warning. Moreover, the device 200 may also include additional alerting mechanisms, such as a sounds or lights. The response and the intensity of these alerts on the device 200 can also be customized according to the transmission 120 received by the device, set by the user, or default settings as manufactured.

The wearable mobile device 200 is preferably implemented with a display 210 for displaying messages included with the transmission or in response to the transmission. These displayed messages preferably provide users with helpful information relating to the transmission. The screen display 210 is preferably illuminated during such an alerting messaging condition to aid the user in reading the message.

In a preferred embodiment of the invention, the device 200 contains active circuitry for conducting ongoing self-diagnostics for reporting malfunction of the device. The self-diagnostics may include a warning of typical malfunctions, such as low battery, failed diagnostic tests, out of range conditions, or any other faults that compromise the functioning of the device and the alarm system. Similarly, in systems where the control panel 114 shown in FIG. 1 includes diagnostics of the alarm system, the control panel 114 may transmit a signal to the device 200 indicating any detected malfunctions for display on the device 200. Thus, the possible transmissions received by the device 200 do not have to relate only to hazard warnings. They may include any malfunctions or status readings of the system. In this way, the user can keep track of the status and functioning of the hazardous condition detection and alerting system, and can take appropriate actions to correct any malfunctions found in the system. As a result, the user is given an up-to-date status of the system, whereas in a conventional alarm system, the user generally does not know something is wrong until the user is able to access the control panel.

Aside from maintenance related messages, the display 210 is especially useful for life threatening messages. However, it is recognized that the device 200 may receive more than one message at a time. In one embodiment, therefore, all competing messages are prioritized such that the life threatening messages are preferably displayed in a font size and in an order that is readable and relays the importance of the message. Such messages take priority over other messages that are not as urgent. As these messages are acknowledged, the lower priority messages may then be displayed.

Along with the basic alert warning, additional information or instructions that would be helpful can be included. For example, displaying the location and the type of hazard can assist the user to avoid walking towards the hazard or the exact location that needs to be addressed. The content of the messages could be preprogrammed with additional instructions edited as needed on the device or from the source of the network transmission. Additional information can also be extracted from the transmission and inserted when it is useful.

In embodiments of the present invention particularly suited for children, a non-silenceable audible alarm could also be activated to assist a parent or rescue worker in locating the user in an emergency. A preferred embodiment of the device 200 includes a wrist strap latching mechanism that is difficult to remove without special tools. This would help keep the device with a person, such as a child, who may require searching to be located during an emergency.

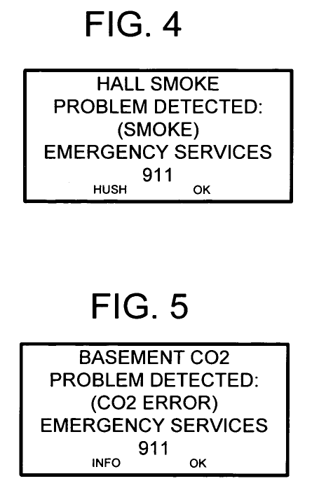

Two exemplary life-threatening messages are shown in FIGS. 4 and 5. A smoke warning message to alert the user of a smoke hazard is shown in FIG. 4, and a carbon monoxide warning message to alert the user of a carbon monoxide hazard is shown in FIG. 5. In this embodiment, because a life-threatening warning message is being displayed, a 911 emergency service message is included to distinguish detected hazards that require assistance of the emergency services. In addition, as shown, the location of the detected hazard is indicated to the user. In this case, the user can avoid the basement as indicated in FIG. 5. These exemplary screens also include messages indicating an action that can be taken by the user. Specifically, the screen of FIG. 4 includes a HUSH command and an OK command. These commands may be activated by selecting them on a touch screen, or by selecting a user input button associated therewith and located in proximity thereto. The OK function simply acknowledges the message. The HUSH function causes the device 200 to transmit a HUSH command to the smoke detector or the control panel 114 to institute a HUSH mode of operation. The INFO command illustrated in FIG. 5 causes the device 200 to send a query message to request additional information about the detected condition or error.

Other messages can also include the following type of information: (1) FIRE ALARM!! UPSTAIRS FIRE ALARM!! LEAVE THE BUILDING; (2) CARBON MONOXIDE ALARM FAMILY ROOM CO DETECTED OPEN WINDOWS MOVE TO FRESH AIR; (3) FLAMMABLE VAPOR DETECTED AT WATER HEATER CAUTION NO SPARKS; (4) HIGH TEMPERATURE 90 DEG. BABY'S ROOM; (5) WATER ALARM BASEMENT; and (6) FREEZE WARNING GARAGE. These exemplary messages are included to show the type of messages that can be included with the present invention, and they should be taken as exemplary of the present invention, and not limiting thereof. Thus, other messages are contemplated and within the scope of the invention.

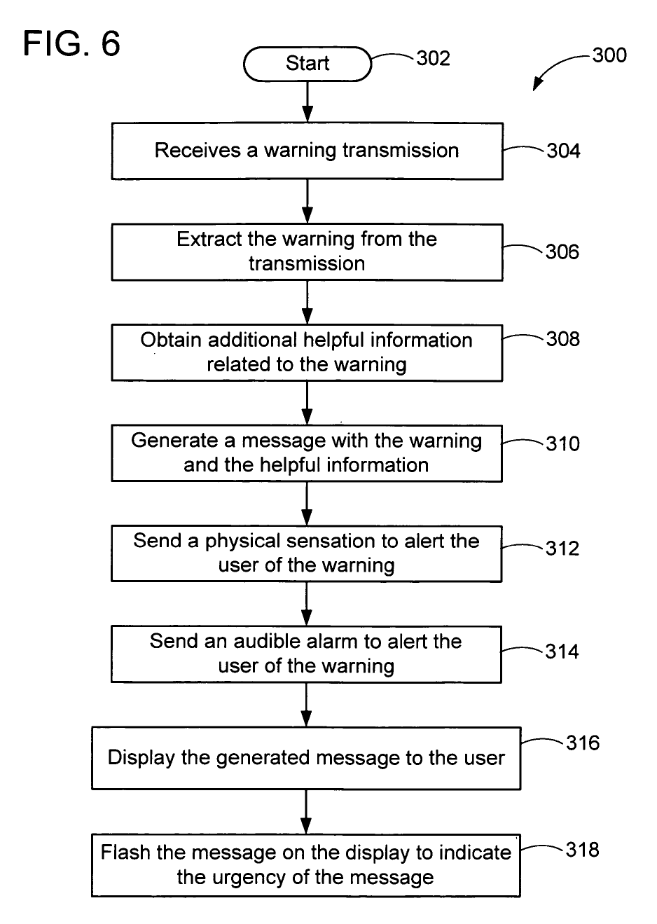

Turning now to FIG. 6, a method for providing hazard warnings that can be implemented with an embodiment of the wearable mobile device 200 is shown and indicated generally at 300. The process starts at step 302 when the device 200 receives a warning transmission at step 304. In response to the received transmission, the warning is extracted from the transmission at step 306. At this time, any additional helpful information relating to the warning is obtained at step 308. A message that includes the warning and the obtained information is generated at step 310. A physical sensation is sent from the device 200 to alert the user of the warning at step 312 if appropriate and/or programmed. The physical sensation is preferably of a magnitude or strength that would wake the user from sleep. In addition, at step 314, an audible alarm is sent out to alert the user as a backup warning. The generated message is displayed to the user on the device at step 316. The message may also be flashed to indicate the urgency of the message as indicated at step 318.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A wearable mobile device comprising:
a receiver adapted to receive a warning transmission from a hazardous condition detection system;
a display adapted to display a message related to the warning transmission to a user; and
means for providing a physical sensation to the user in contact with the wearable mobile device to alert the user of the warning transmission.

2. The device according to claim 1, wherein the receiver is adapted to receive warning transmissions from at least one of a broadcasted public hazard warning system, a local hazard warning system, an individual hazardous condition detector.

3. The device according to claim 1, wherein the physical sensation is of a sufficient magnitude to wake the user from sleep.

4. The device according to claim 1, wherein the physical sensation comprises at least one of a vibration, a temperature change, and an electrical shock.

5. The device according to claim 1, further comprising an audible alarm to alert the user of the received warning transmission.

6. The device according to claim 1, wherein the display flashes the displayed message to indicate the urgency of the warning transmission.

7. The device according to claim 1, further comprising a wearable housing having a wristband, and wherein the physical sensation is provided through at least one of the wearable housing and the wristband.

8. The device according to claim 1, wherein the display is illuminated when the message is displayed.

9. The device according to claim 1, wherein the receiver is adapted to receive at least one of radio waves, infrared radiation, and audio.

10. The device according to claim 1, further comprising a transmitter adapted to transmit signals to the hazardous condition detection system.

11. The device according to claim 10, wherein the transmitter is adapted to transmit control signals to the hazardous condition detection system.

12. The device according to claim 10, wherein the transmitter is adapted to transmit diagnostic signals to the hazardous condition detection system.

13. The device according to claim 1, wherein the means for providing a physical sensation provides a physical sensation of variable magnitude.

14. The device according to claim 13, further comprising priority logic for prioritizing messages related to the warning transmissions.

15. A hazard warning system, comprising:
a hazardous condition detector adapted to detect a hazardous condition within an environment, the hazardous condition detector transmitting an alert when the hazardous condition is detected, the hazardous condition detector further generating an audible alarm when the hazardous condition is detected; and
a wearable mobile device including a receiver adapted to receive the alert, the wearable mobile device further including means for generating a physical sensation to alert a user of the hazardous condition in response to receipt of the alert.

16. The system of claim 15, wherein the wearable mobile device further comprises a display screen, the wearable mobile device providing a warning message on the display screen in response to the receipt of the alert.

17. The system of claim 16, wherein the display is illuminated when the warning message is displayed.

18. The system of claim 15, wherein a magnitude of the physical sensation is of sufficient to wake the user from sleep.

19. The system of claim 18, wherein a magnitude of the physical sensation is variable.

20. The system of claim 15, wherein the means for generating the physical sensation includes at least one of a vibration, a pinch, a temperature change, and a shock.

21. The system of claim 15, further comprising a wristband to facilitate wearing of the wearable mobile device.

22. The system of claim 15, wherein the receiver is adapted to receive at least one of radio waves, infrared radiation, and audio.

23. The system of claim 15, wherein the wearable mobile device further comprises a transmitter adapted to transmit signals to the hazardous condition detector.

24. The system of claim 16, further comprising:
a second hazardous condition detector adapted to detect a second hazardous condition, the second hazardous condition detector transmitting a second alert when the second hazardous condition is detected, the second hazardous condition detector further generating a second alarm when the second hazardous condition is detected;
wherein the receiver of the wearable mobile device is adapted to receive the second alert, and
wherein the wearable mobile device provides a second warning message on the display screen in response to the receipt of the second alert.

25. The system of claim 24, wherein the wearable mobile device further includes priority logic to prioritize display of the warning message and the second warning message.

26. The system of claim 15, further comprising:
a control panel;
wherein the hazardous condition detector is wired to the control panel;
wherein the hazardous condition detector transmits the alert to the control panel via a wired connection; and
wherein the control panel transmits the alert to the wearable mobile device wirelessly.

27. A method for providing hazard warnings comprising the steps of:
receiving a warning transmission;
displaying a message related to the warning transmission to a user; and
sending a physical sensation to alert the user of the received transmission warning, wherein the physical sensation is of a sufficient magnitude to wake the user from sleep.

28. The method of claim 27, further comprising the steps of:
extracting the warning from the transmission;
obtaining additional helpful information related to the warning; and
generating a message with the warning and the obtained helpful information.

29. The method of claim 27, further comprising the step of sending an audible alarm to alert the user of the received transmission warning.

30. The method of claim 27, further comprising the step of flashing the displayed message to indicate the urgency of the message to the user.

31. The method of claim 27, further comprising the step of varying an intensity of the physical sensation.
